(19) United States
(12) Patent Application Publication
(10) Pub. No.: US 2002/0120579 A1
(43) Pub. Date: Aug. 29, 2002

(54) Method for updating a license period of a program, method for licensing the use of a program, and information processing system and program thereof

(75) Inventors: Yoshifumi Kawaguchi, Yamato-shi (JP); Katsuhiro Nakagaki, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/085,296

(22) Filed: Feb. 28, 2002

(30) Foreign Application Priority Data
Feb. 28, 2001 (JP) 2001-055976

(51) Int. Cl. G06F 17/60

(52) U.S. Cl. 705/59

(57) ABSTRACT

An object of the present invention is to provide a method and system for automatically updating a license period of a program. A method comprises the steps of: determining whether the current date and time is within a license period of the program; issuing a request to an index server for transmission of an index file; receiving the index file from the index server; issuing an authentication request with an address of an authentication server contained in the index file; receiving authentication information from the authentication server; updating the license period of the program when the authentication is successful; and executing the program.

### FIELD OF THE INVENTION

The present invention relates to a method, information processing system and program for updating a license period of a program, and more particularly to a technique for simplifying the update of a license when a license period has expired without forcing a user to undertake a cumbersome procedure.

### BACKGROUND ART

Since a computer program is protected by a copyright, it is common that its use is approved on a license basis. Generally, for commercial software, a user is granted a license for personal use when he or she obtains a program, wherein no expiration date for use may be set specifically in some cases.

However, in case of so-called shareware or a trial program, it is used on trial for free or at a low price for a certain period of time, thereafter a user who desires a further use is given a license. It is often the case that a license period is set in such license.

It is commonly the case that a license key or product key is given to a program with a license period set, wherein all functions of the program can be performed contingent on a legal key and legal period information. That is, a user can not use the program unless he or she inputs the legal key information issued from a licenser and the use is within the license period.

Accordingly, a user needs to acquire a new license key from a licensor (i.e., program provider) if he or she desires to further use the program when the license period has expired. Acquisition of a new license key is commonly achieved by the following procedure: (1) a request to update a license from a user by means of a mail or the like, (2) authentication of the request for update by a program provider, (3) issuance and transmittal of an update key by the program provider, and (4) application of the update key by the user.

However, the procedure described above for a request, issuance and acquisition of a new license key (i.e., update key) is cumbersome for both users and program providers. Namely, a user needs to do the update procedure, which he or she has hardly worried about during a license period, while a program provider has to cope with a request from a user individually. Furthermore, a user has to apply a new update key each time. Although it is conceivable to prolong the license period considerably in order to simplify such an office procedure, this policy is opposed to a demand to withdraw a consideration effectively by making the license period short.

In addition, in the case where a certain club is formed and a certain program is licensed comprehensively for its members, it makes an office procedure for authentication enormous to accept a request to update a license for each program, thus efficiency is strongly required.

It is therefor an object of the present invention to make the office work efficient for authentication of updating a license period of a program. It is another object of the invention to provide a technique for updating a license period automatically. It is a further object of the invention to provide a system for updating a license that is highly convenient both for users and program providers. It is a further object of the invention to provide a system and method for updating a license that excels in not only convenience but also in security and flexibility.

### SUMMARY OF THE INVENTION

The present invention is summarized as a method for updating a license period of a program which comprises a first determination step of determining whether the current date and time is within a license period of the program; a step of issuing a request to an index server for transmission of an index file if a determination made by the first determination step is false; a step of receiving the index file from the index server; a step of issuing an authentication request to an authentication server with an address of the authentication server contained in the index file; and a step of receiving authentication information from the authentication server. A second determination step determines whether information indicative of success of authentication is contained in the authentication information; and a step of updating the license period of the program if a determination made by the second determination step is true.

The first determination step may be performed upon activation of the program, and the program may become executable after updating the license period. Moreover, the method wherein address information of the authentication server contained in the index file is encrypted, may further comprise the step of decrypting the encrypted address information. Furthermore, the authentication request may contain user identification information to determine whether a user belongs to a group that is licensed to use the program. In addition, a display screen may be displayed before issuing the authentication request, which requires inputting of the user identification information and, if necessary, a password. Furthermore, this display screen may display information about the terms of the license of the program.

According to the present invention, the expiration of a license period is automatically determined and an authentication request is automatically issued to a licenser or program provider (e.g., authentication server). Then, a result of authentication is sent back from the authentication server to a user and a license period is automatically updated. Accordingly, the user does not have to send a request for issuance of an update key and can easily acquire a license of the program again. On the other hand, a program provider can automate the authentication since a request for update is sent by being formulated from a user. Moreover, since a request for update is performed by referring to an index server, it is easy to change the authentication server. That is, even if the authentication server is changed, there is no need to send an address to a user, whereby an address of the authentication server can be changed only by updating an index file of the index server. In addition, since a user acquires address information of the authentication server from the index server, there is no need to publish an address of the authentication server, whereby the security of the authentication server is enhanced. Furthermore, the address information transmitted may be encrypted, thus the security is further enhanced.

The present invention is suitable when licensing a program to an organization consisting of a plurality of member users, for example. A program provider manages user identification information as a membership number, wherein a user is granted a license to use the program as long as he or she is a member. In this case, upon automatic update of the license period, a user sends user identification information (e.g., membership number) and a password to the authentication server, which certify a user to be a member. According to the present invention, an input screen is provided to input such a membership number (i.e., identification information). The authentication server grants authentication by referring to a membership database if a user is a valid member.

In another aspect of the invention, there is provided a method for licensing the use of a program, the method comprising the steps of: receiving a request from a user; creating or selecting an index file containing address information of a server that grants authentication regarding a license of the program to be used by the user in response to receipt of the request; and sending the index file to the user who issued the request. The address information contained in the index file may be encrypted. Using this method, a user can acquire the index file.

It should be noted that the method of the present invention could be comprehended as a system or program as well.

### BRIEF DESCRIPTION OF THE DRAWINGS

FIG. 1 is a conceptual diagram of an example system applicable to a method for updating a license period according to the embodiment of the present invention.

FIG. 2 is a diagram schematically showing the update of the license period in time series according the embodiment of the present invention.

FIG. 3 is a block diagram showing an example configuration of client 2, index server 3 and authentication server 4.

FIG. 4 is a flowchart of an example method for updating a license period according to the embodiment of the present invention.

FIG. 5 depicts an example of an index file sent from index server 3.

FIG. 6 depicts an example of an index file after decryption.

FIG. 7 depicts an example screen for inputting a membership number and a password.

FIG. 8 is a block diagram showing another embodiment of the present invention.

FIG. 9 is a block diagram showing a further embodiment of the present invention.

### DETAILED DESCRIPTION OF A PREFERRED EMBODIMENT

Now the present invention will be described with reference to the accompanying drawings. However, it should be noted that the present invention could be implemented in many different manners, thus should not be comprehended to be limited to the embodiments described herein. Throughout the drawings, the same elements are shown with the same reference numbers.

In the following embodiment of the present invention, a method and system will be mainly described, however, it would be obvious to those ordinary skilled in the art that the present invention could also be implemented as a program available in a computer. Therefore, the present invention may be implemented in hardware, software and a combination thereof. The program may also be recorded on any computer-readable medium such as a hard disk, CD-ROM, optical storage or magnetic storage.

Furthermore, in the following embodiment, a typical computer system can be used as a client system and a server system. A computer system used in the embodiment may comprise hardware resources quipped in a typical computer system, including a central processing unit (CPU), main storage (main memory, i.e., RAM), nonvolatile storage (ROM), coprocessor, image accelerator, cache memory, input/output controller (I/O), etc. In addition, an external storage such as a hard disk drive and communication means to connect to a network such as the Internet may be provided as well. Such a computer system includes various kinds of computers such as a personal computer, workstation, mainframe computer, etc.

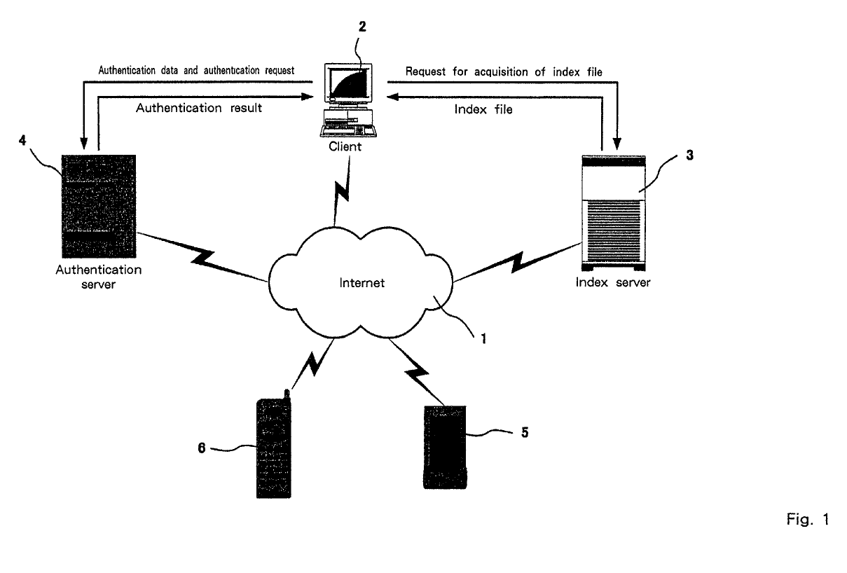

FIG. 1 is a conceptual diagram of an example system applicable to a method for updating a license period according to the embodiment of the present invention. The system in the embodiment comprises the Internet 1, a computer system 2 of a client, an index server 3, and an authentication server 4.

As is well known in the art, the Internet 1 is one type of network that is open globally where communication is performed according to the IP (Internet Protocol). Here the Internet is exemplified, however, other types of networks can be used as well. They include networks connected by dedicated telephone lines or cable networks such as CATV. The concept of the Internet includes an intranet that is limited to be used by specific people.

Computer system 2 of the client (hereinafter simply referred to as client 2) is a computer system of a user who uses a program the license of which is granted by a program provider. A program is exemplified by an application program. In the following description, client 2 is exemplified by a typical computer system, however, a cellular phone 6, a personal digital assistant (PDA) 7, etc., may be used as client 2. Furthermore, there is shown a single client 2 in FIG. 1, it goes without saying that there may be a plurality of clients 2.

Index server 3 is responsible to send an index file, which includes a URL (uniform resource locator) of authentication server 4, to a user in response to a user's request. Authentication server 4 is responsible to grant authentication in response to a request from a user for update of the license period. Index server 3 and authentication server 4 could be implemented by using a typical computer system as mentioned earlier. In FIG. 1, although index server 3 and authentication server 4 are represented as a single one respectively, these may be comprised of a plurality of corresponding ones respectively.

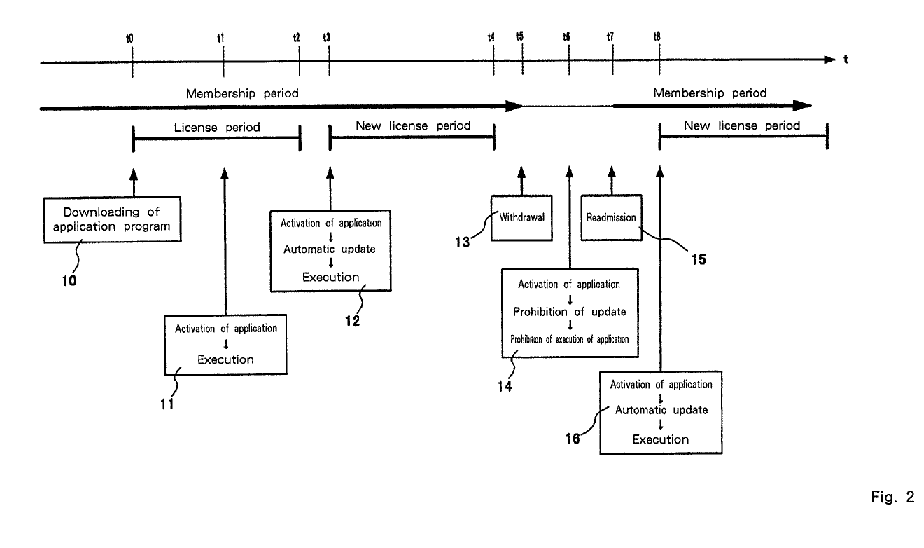

FIG. 2 is a diagram schematically showing the update of the license period in time series according the embodiment of the present invention. It is assumed that at time t0 a user downloads an application program (step 10). It is also assumed that at this time the user is a member of a group that is managed by a program provider. It is further assumed that a license period of the application program starts just upon the downloading and the license is valid during a period from time t0 to time t2. This period is to become a license period the user agreed to when he or she installs the program. When the user activates the application program at time t1, that application program is executed since the license is valid (step 11).

Conventionally, when the user tries to execute the application program at time t3 after the license period has expired at time t2, the program could not be executed since the license is not valid. On the contrary, according to the present invention, user authentication is automatically performed upon activation of the application program and then the license period is automatically updated (step 12). In this case, user's membership is still valid, thus authentication succeeds and then the license period is updated until time t4 so that the application program will become executable. It should be noted that the license period (t3 to t4) upon this update may be different from the license period (t0 to t2) at the time when that program was installed. The license period updated complies with a license agreement upon update. For example, when distributing a program at a low cost for the purpose of trial use and thereafter requiring the payment of consideration formally to use the program, the license period for trail use (i.e., license period when downloading the program) may be set to about one month while the license period upon the formal contract may be prolonged to about one year.

After the user withdraws from membership at time t5 (step 13), if he or she activates the application program at time t6 within the period during which he or she does not have the membership, the system of the present invention verifies the authentication as mentioned above, but fails in the authentication because the membership of the user is invalid. As a result, the license period will not be updated so that the application program will not be able to be executed (step 14).

However, if it is assumed that the user joins the group again at time t7 (step 15), when he or she thereafter executes the application program at time t8, the license becomes valid like in step 12 described above, so that the application program will be able to be executed (step 16). Namely, according to the system of the embodiment of the present invention, the authentication is granted to the user as long as his membership is valid, whereby the application program is able to be used.

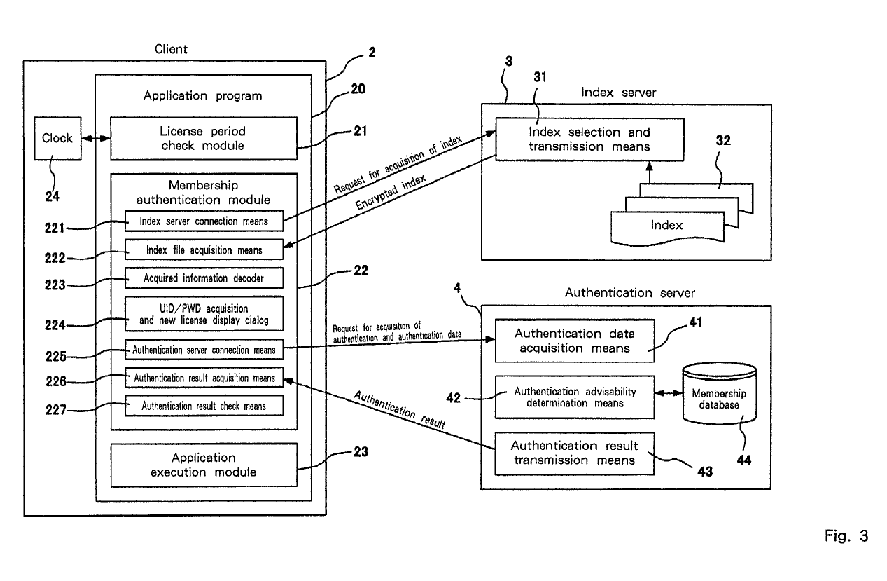

FIG. 3 is a block diagram showing an example configuration of client 2, index server 3 and authentication server 4.

Client 2 has an application program 20, which comprises license period check module 21, membership authentication module 22, and application execution module 23. In addition, client 2 has a clock 24.

Application program 20 is a program provided by a program provider. It should be noted that an application program is exemplified here, however, a program provided by a program provider is not limited to an application program. For example, it may be a system program run on a specific system or a macro program available for a specific application.

License period check module 21 is activated upon activation of the application program and has a function of determining whether the current time is within the license period. The current time is acquired from clock 24. Information about the license period may be stored in another system connected by a proper communication line as well as stored in any storage area in some system within client 2. In this case, license periods of many users are able to be managed in a centralized manner. License period check module 21 also has such a communication function, thus it has means for acquiring appropriate information.

Membership authentication module 22 comprises index server connection means 221, index file acquisition means 222, acquired information decoder 223, UID/PWD acquisition and new license display dialog 224, authentication server connection means 225, authentication result acquisition means 226, and authentication result check means 227.

Index server connection means 221 issues a request to index server 3 to acquire an index file. This request may include information necessary to select an appropriate index file, such as a product number of an application program.

Index file acquisition means 222 receives the index file sent from index server 3. Acquired information decoder 223 decrypts a cipher contained in the received index file. According to the embodiment of the present invention, the index file may be encrypted, thereby enhancing the security of the system, particularly the security for the address information of authentication server 4.

UID/PWD acquisition and new license display dialog 224 functions to acquire user identification information such as a membership number, which is necessary for an authentication request to authentication server 4, and a password. It also functions to display the contract detail of the new license that is to be granted after authentication. The contract document of the new license is sent from index server 3 with being contained in the index file, so that the new contract detail is displayed at every update of the license.

Authentication server connection means 225 issues an authentication request to authentication server 4. The authentication request may contain user identification information (UID) described above and a password (PWD). Authentication result acquisition means 226 acquires the authentication result sent from authentication server 4. Authentication result check means 227 checks the authentication result acquired and updates the license period to allow execution of the application program if the authentication succeeded. Application execution module 23 executes the application program.

Index server 3 comprises index selection and transmission means 31 and index 32. In response to a request for transmission of an index file, index selection and transmission means 31 selects an appropriate index file from index 32 or creates an appropriate index file, and then sends the index file to client 2. Preferably, an index file is created in advance for each user or for each application program and recorded in index 32. In order to select or create an index file, a serial number of the application program or a user number, which is contained in the request for transmission from the user, may be referred.

Authentication server 4 comprises authentication data acquisition means 41, authentication advisability determination means 42, authentication result transmission means 43, and membership database 44. Authentication data acquisition means 41 receives an authentication request and authentication data (UID and PWD) included therein from client 2. The authentication data may include data other than UID and PWD. Authentication advisability determination means 42 determines whether or not to authenticate based on the authentication data. This determination is made by referring to membership database 44. For example, where membership database 44 is composed of UIDs and PWDs of members who are presently valid, the determination is made by matching the UID and PWD sent from a user with those stored in membership database 44. It should be noted that membership database 44 may not be included in authentication server 4, but may be included in another system. Authentication result transmission means 43 sends the authentication result determined by authentication advisability determination means 42 to client 2.

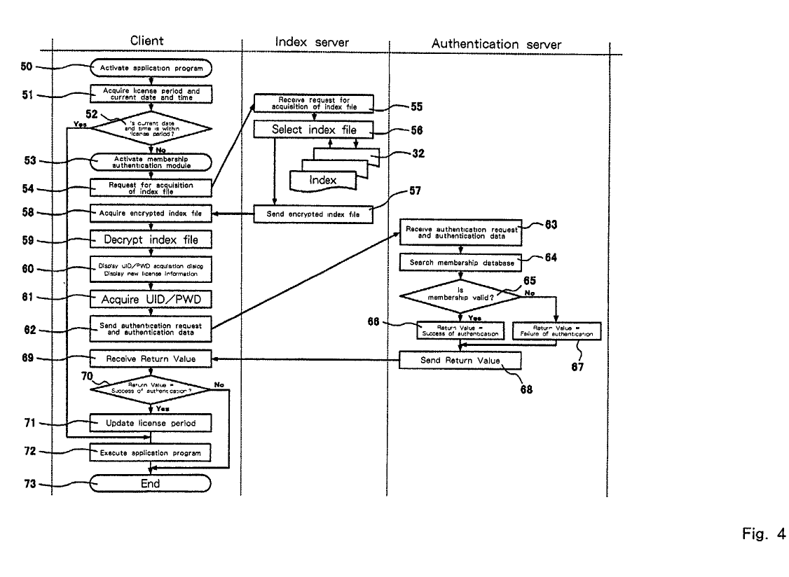

FIG. 4 is a flowchart of an example method for updating a license period according to the embodiment of the present invention. First, an application program is activated in step 50.

After the application program is activated, the program acquires the license period and the current date and time (step 51), and determines whether the current date and time is within the license period (step 52). If it is within the license period, the program goes to step 72 and performs this application program (step 72). In this case, the license is valid so that no authentication for membership according to the present invention is performed, whereby the application program is executed quickly.

If the current date and time is out of the license period, the license is presently invalid, thus membership authentication module 22 is activated (step 53). Being activated, membership authentication module 22 issues a request for acquisition of an index file to index server 3 (step 54).

In receipt of this request (step 55), index server 3 selects or creates an index file (step 56). This selection or creation is performed referring to index 32. At this stage, index server 3 may encrypt the index file. Preferably, index files are encrypted in advance and recorded in the index file 32 as encrypted index files. Thereafter, index server 3 sends the encrypted index file to client 2 (step 57).

The index file contains a URL of authentication server 4, as described above. In this way, since a user acquires the URL of authentication server 4 by referring to index server 3, there is no need for authentication server 4 to publish its own URL. In addition, client 2 can always acquire the latest URL of authentication server 4 when accessing the index server 3 as long as client 2 uses membership authentication module 22 according to the present invention. Consequently, a user may have no interest in the URL of authentication server 4 even if it changes. In addition, when authentication server 4 changes its own URL, all that is required is to change index files of index server 3, so that authentication server 4 does not need to notify or make contact with users.

As the index file could be encrypted, the security of the system, particularly the security for the address of authentication server 4 is enhanced. It should be noted that the index file may include information such as a license period and the terms of the license of the program as well as the URL of authentication server 4.

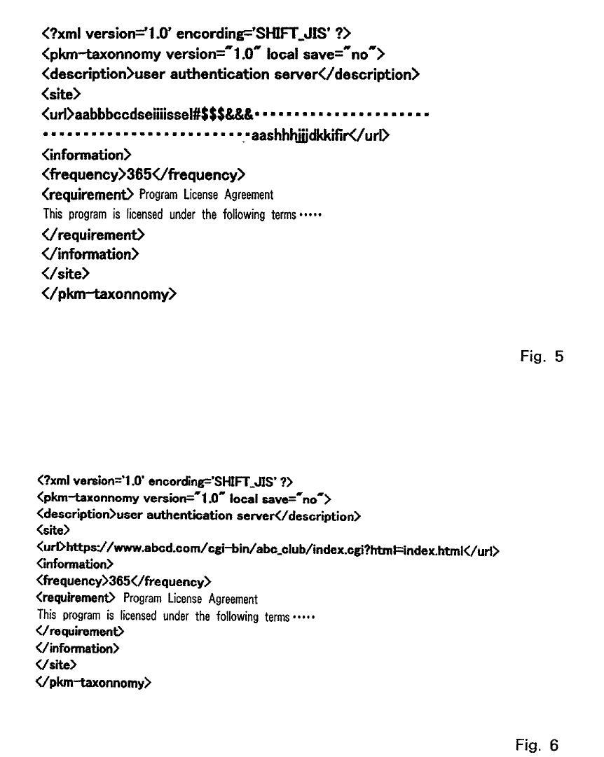

FIG. 5 depicts an example of an index file sent from index server 3. This file is described in XML (Extensible Markup Language). Here the URL of authentication server 4 is described with being encrypted between “url” tags. In addition, in a portion between “information” tags, there is provided text concerning a license period shown between “frequency” tags and the terms of the license shown between “requirement” tags.

Next, after client 2 receives the encrypted index file (step 58), it decrypts this cipher to obtain a plain index file (step 59). FIG. 6 depicts an example of an index file after decryption. Compared with FIG. 5, a portion between “url” tags is converted to meaningful plain text.

It should be noted that here is shown an example where a portion of the index file is encrypted and thereafter decrypted, however, the entire index file may be encrypted.

Then, client 2 displays a screen for inputting UID (User ID: membership number) and PWD (password) (step 60). This screen may also display the terms of the license of the program at the same time.

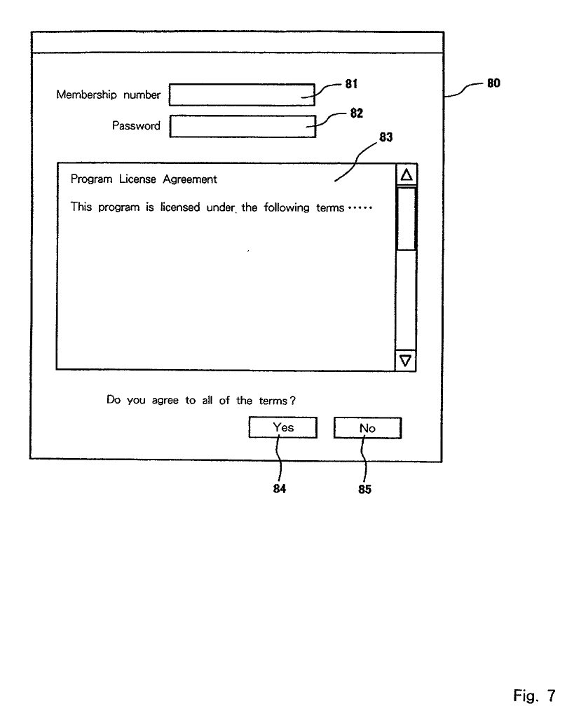

FIG. 7 depicts an example screen for inputting a membership number and a password. Within window 80 are provided field 81 for inputting a membership number and field 82 for inputting a password. Within a sub-window 83 is displayed the terms of the license of the program. When a user agrees to the new terms of the license, he or she clicks a “Yes” button 84, while he or she clicks a “No” button 85 when not agreeing to the terms of the license.

Then, client 2 acquires UID and PWD from data input to fields 81 and 82 (step 61), making these data be authentication data. It should be noted that here is shown an example where authentication data is acquired from user input, however, user information may be stored in some system of client 2, wherein necessary data is acquired from this user information to make it be authentication data.

Then, client 2 issues a request to authentication server 4 for acquisition of authentication (step 62). This request contains authentication data such as UID or PWD acquired in the aforementioned step.

Next, authentication server 4 receives the authentication request from client 2 along with authentication data (step 63). Upon receipt of this request, authentication server 4 searches membership database 44 (step 64), and determines whether the membership subject to the authentication request is valid (step 65). If the membership is valid, it generates a return value for success of authentication (step 66), while if the membership is invalid, it generates a return value for failure of authentication (step 67). Then, the return value is sent to client 2 as the authentication result.

Client 2 receives the return value (step 69) and determines whether the return value indicates the success of authentication (step 70). If successful, it updates the license period to a new license period and executes the application program (step 72). Thereafter, the processing is terminated (step 73). If authentication failed, client 2 terminates the processing without updating the license period and executing the application program (step 73).

According to the embodiment of the present invention, when executing a program the license period of which has expired, there is no need to apply for a new license or to apply for update of the license period to a program provider. According to the present invention, the passing of license period is automatically determined and authentication is automatically acquired. (However, user ID (e.g., membership number) and password are required to be input.) Furthermore, according to the present invention, since the address of authentication server 4 is acquired from index server 3, the address of authentication server 4 may be easily changed. In addition, an index file is acquired every authentication, the latest data is presented to a user, including the latest terms of the license, etc. Moreover, the security of the system is enhanced by encrypting the index file.

As mentioned above, the present invention has been specifically described according to the embodiments, however, the present invention is not limited to those embodiments and is able to be modified without departing the scope and spirit of the appended claims.

For example, in the above embodiments, the license is granted from the initial stage of the use of the program, however, it is possible that the license for trial use is granted at the initial stage and thereafter the formal license is granted.

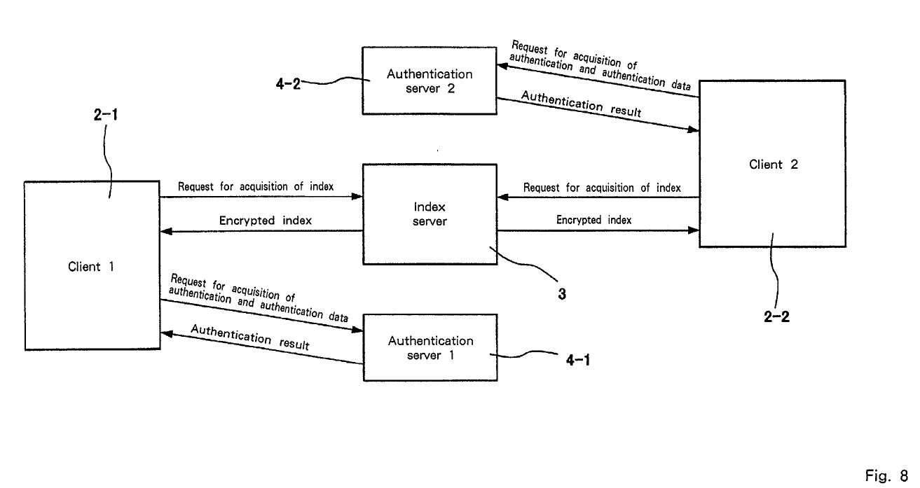

In addition, in the above embodiments, there is provided a single authentication server 4, however, there may be provided a plurality of authentication servers such as those 4-1 and 4-2 shown in FIG. 8. The present invention is also applicable where a user is provided programs from different program providers, wherein an authentication server is installed for each program provider and the program provider conducts its own user (or member) management. In this case, a single index server is shared as shown in FIG. 8 even if the program providers are different.

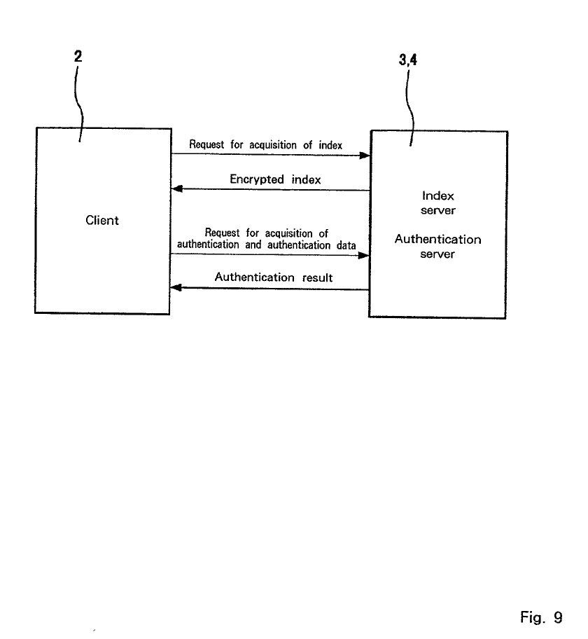

Furthermore, as shown in FIG. 9, an index server and an authentication server may be configured as a single server.

Besides, the present invention can set the license period freely. Therefore, the present invention can provide a system that is secure and convenient both for program providers and users who desire to set a license period freely.

In the embodiments mentioned above, part of or all of an index file is encrypted, however, an index file may not be encrypted.

As mentioned above, according to the present invention, the following effects are accomplished. That is, the office work is made efficient for authentication of update of a license period of a program. Furthermore, a system is provided that updates a license period automatically and is convenient both users and program providers. In addition, a system and method for updating a license is provided that excels in security and flexibility.

What is claimed is:

1. A method for updating a license period of a program; comprising:
a first determination step of determining whether a current date and time is within a license period of the program;
a step of issuing a request to an index server for transmission of an index file if a determination made by said first determination step is false;
a step of receiving the index file from said index server;
a step of issuing an authentication request to an authentication server with an address of the authentication server contained in said index file;
a step of receiving authentication information from said authentication server;
a second determination step of determining whether information indicative of success of authentication is contained in said authentication information; and
a step of updating the license period of said program if a determination made by said second determination step is true.

2. The method according to claim 1, wherein said first determination step is performed upon activation of said program, and wherein said program becomes executable after updating said license period.

3. The method according to claim 1, wherein address information of said authentication server contained in said index file is encrypted, further comprising the step of decrypting the encrypted address information of said authentication server.

4. The method according to claim 1, wherein said authentication request contains user identification information to determine whether a user belongs to a group that is licensed to use said program.

5. The method according to claim 4, further comprising the step of displaying a display screen before issuing said authentication request, the display screen requiring inputting of said user identification information and, if necessary, a password.

6. The method according to claim 5, wherein said index file contains information about the terms of the license of the program, and wherein said display screen displays information about the terms of the license of said program in addition to the requirement of inputting said user identification information and said password.

7. A method for licensing the use of a program, comprising the steps of:
receiving a request from a user;
creating or selecting an index file containing address information of a server that grants authentication regarding a license of the program to be used by the user in response to receipt of the request; and
sending said index file to the user who issued said request.

8. The method according to claim 7, wherein said address information contained in said index file is encrypted.

9. An information processing system; comprising:
first determination means for determining whether a current date and time is within a license period of a program;
means for issuing a request to an index server for transmission of an index file if a determination made by said first determination means is false;
means for receiving the index file from said index server;
means for issuing an authentication request to an authentication server with an address of the authentication server contained in said index file;
means for receiving authentication information from said authentication server;
second determination means for determining whether information indicative of success of authentication is contained in said authentication information; and
means for updating the license period of said program if a determination made by said second determination means is true.

10. The information processing system according to claim 9, wherein said first determination means is performed upon activation of said program, and wherein said program becomes executable after updating said license period.

11. The information processing system according to claim 9 wherein address information of said authentication server contained in said index file is encrypted, further comprising means for decrypting the encrypted address information of said authentication server.

12. The information processing system according to claim 9, wherein said authentication request contains user identification information to determine whether a user belongs to a group that is licensed to use said program.

13. The information processing system according to claim 12, further comprising means for displaying a display screen requiring inputting of said user identification information and, if necessary, a password.

14. The information processing system according to claim 13, wherein said index file contains information about the terms of the license of said program, and wherein said display screen displays information about the terms of the license of said program in addition to the requirement of inputting said user identification information and said password.

15. An information processing system, comprising:
means for receiving a request from a user;
means for creating or selecting an index file containing address information of a server that grants authentication regarding a license of a program to be used by said user in response to receipt of said request; and
means for sending said index file to the user who issued said request.

16. The information processing system according to claim 15, wherein said address information contained in said index file is encrypted.

17. A computer program product comprising a computer usable medium having computer program logic recorded thereon for enabling a processor in a computer system to manage a license of a program, the computer program logic; comprising:
first determination means for enabling the processor to determine whether a current date and time is within a license period of the program;
means for enabling the processor to issue a request to an index server for transmission of an index file if a determination made by said first determination function is false;
means for enabling the processor to receive the index file from said index server;
means for enabling the processor to issue an authentication request to an authentication server with an address of the authentication server contained in said index file;
means for enabling the processor to receive authentication information from said authentication server;
second determination means for enabling the processor to determine whether information indicative of success of authentication is contained in said authentication information; and
means for enabling the processor to update the license period of said program if a determination made by said second determination function is true.

18. A computer program product comprising a computer usable medium having computer program logic recorded thereon for enabling a processor in a computer system to manage a license of a program, the computer program logic, comprising:
means for enabling the processor to receive a request from a user;
means for enabling the processor to create or select an index file containing address information of a server that grants authentication regarding a license of a program to be used by said user in response to receipt of said request; and
means for enabling the processor to send said index file to the user who issued said request.
